(19) United States
(12) Patent Application Publication
(10) Pub. No.: US 2015/0110510 A1
(43) Pub. Date: Apr. 23, 2015

(54) TRANSFER DEVICE AND IMAGE FORMING APPARATUS

(71) Applicant: FUJI XEROX CO., LTD., Tokyo (JP)

(72) Inventor: Takatoshi ISHIKAWA, Kanagawa (JP)

(73) Assignee: FUJI XEROX CO., LTD., Tokyo (JP)

(21) Appl. No.: 14/295,788

(22) Filed: Jun. 4, 2014

(30) Foreign Application Priority Data
Oct. 22, 2013 (JP) 2013-219331

(51) Int. Cl. G03G 15/16

(52) U.S. Cl. CPC G03G 15/80
USPC 399/66

(57) ABSTRACT

Provided is a transfer device including a transfer roll that interposes a sheet transported to a transfer unit to transfer the toner image to the sheet, a power supply that generates a voltage between the transfer roll and the image holding member, and a control unit that causes the power supply to generate a transfer voltage, a resistance detection voltage having a same polarity as a polarity of the transfer voltage, and a cleaning voltage having a polarity reverse to the polarity of the transfer voltage, wherein the control unit causes the power supply to generate the transfer voltage in a transfer interval, in a continuous traveling mode, and generates the resistance detection voltage and the cleaning voltage in a non-arriving interval while switching a single interval ratio which is a generation time ratio in the non-arriving interval between the resistance detection voltage and the cleaning voltage.

### CROSS-REFERENCE TO RELATED APPLICATIONS

This application is based on and claims priority under 35 USC 119 from Japanese Patent Application No. 2013-219331 filed Oct. 22, 2013.

### BACKGROUND

### Technical Field

The present invention relates to a transfer device and an image forming apparatus.

### SUMMARY

According to an aspect of the invention, there is provided a transfer device including:

a transfer roll that interposes a sheet transported to a transfer unit between the transfer roll and an image holding member which holds a toner image and carries the toner image to the transfer unit, to transfer the toner image to the sheet;

a power supply that generates a voltage between the transfer roll and the image holding member; and

a control unit that causes the power supply to generate a transfer voltage for transferring the toner image onto the sheet, a resistance detection voltage having a same polarity as a polarity of the transfer voltage, and a cleaning voltage having a polarity reverse to the polarity of the transfer voltage,

wherein the control unit causes the power supply to generate the transfer voltage in a transfer interval in which each sheet passes through the transfer unit, in a continuous traveling mode in which toner images are transferred to the plural continuously transported sheets, and generates the resistance detection voltage and the cleaning voltage in a non-arriving interval in which a sheet has already passed through the transfer unit and a next sheet has not arrived at the transfer unit while switching a single interval ratio which is a generation time ratio in the non-arriving interval between the resistance detection voltage and the cleaning voltage, during the continuous traveling mode.

### BRIEF DESCRIPTION OF THE DRAWINGS

Exemplary embodiments of the present invention will be described in detail based on the following figures, wherein:

FIG. 1 is a schematic configuration diagram of a printer corresponding to one exemplary embodiment of an image forming apparatus of the exemplary embodiment of the invention; and

FIGS. 2A to 2D are diagrams transversely showing switching sequences of various voltages in a continuous travelling mode.

### DETAILED DESCRIPTION

Hereinafter, exemplary embodiments of the invention will be described with reference to the drawings.

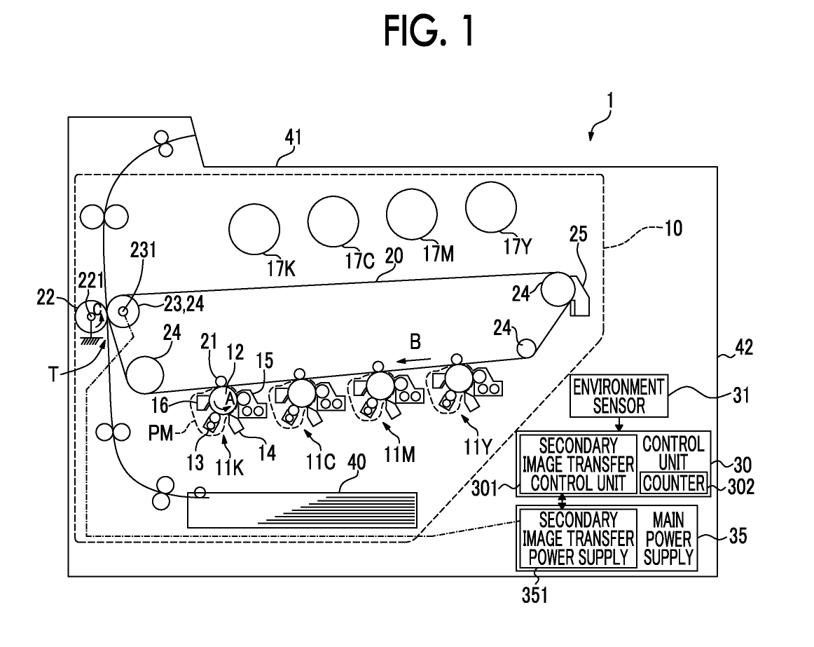

FIG. 1 is a schematic configuration diagram of a printer corresponding to one exemplary embodiment of an image forming apparatus of the exemplary embodiment of the invention. One exemplary embodiment of a transfer device of the exemplary embodiment of the invention is embedded in this printer.

A printer 1 shown in FIG. 1 is a so-called tandem type color printer, and includes an image formation processing unit 10 which performs image formation, a control unit 30 which controls the entire operation of the printer 1, and a main power supply 35 which supplies power to each unit. The image formation processing unit 10, the control unit 30, and the main power supply 35 are embedded in a housing 42.

The housing 42 includes a plastic cover portion which mainly forms an appearance of the printer 1, and a frame portion which mainly configures frames of the printer 1 to hold the entire structure of the printer 1.

The image formation processing unit 10 includes four image forming units 11Y, 11M, 11C, and 11K (hereinafter, also collectively simply referred to as an “image forming unit 11”) which are disposed in parallel with each other at constant intervals. Each image forming unit 11 includes a photoreceptor drum 12 on which an electrostatic latent image or a toner image is formed on the surface thereof, a charger 13 which charges the surface of the photoreceptor drum 12, an LED printer head (LPH) 14 which exposes the surface of the photoreceptor drum 12 to light based on image data, a developing unit 15 which develops the electrostatic latent image formed on the photoreceptor drum 12, and a cleaner 16 which cleans the surface of the photoreceptor drum 12 after transfer.

Each image forming unit 11 has the same configuration except for different toner colors accommodated in the developing unit 15. The image forming units 11Y, 11M, 11C, and 11K form yellow (Y), magenta (M), cyan (C), and black (K) toner images, respectively. The toner having each color is supplied to each developing unit 15 of each of the image forming units 11Y, 11M, 11C, and 11K, from toner cartridges 17Y, 17M, 17C, and 17K corresponding to each image forming unit 11 through a supply path (not shown).

The image formation processing unit 10 further includes an intermediate image transfer belt 20, a primary image transfer roll 21, a secondary image transfer roll 22, and a fuser 45.

The intermediate image transfer belt 20 is an endless belt which is stretched between plural rolls 24 including a backup roll 23 which is disposed on a position opposing to the secondary image transfer roll 22 with the intermediate image transfer belt 20 interposed therebetween, and circularly moves in a direction of an arrow B. Each color toner image formed on the photoreceptor drum 12 of each image forming unit 11 is subjected to multi layer transfer onto this intermediate image transfer belt 20.

The primary image transfer roll 21 sequentially transfers each color toner image formed by each image forming unit 11 to the intermediate image transfer belt 20.

The second transfer roll 22 collectively transfers the toner image which is sequentially transferred onto the intermediate transfer belt 20 to a sheet while rotating in a direction of an arrow C.

The fuser 45 fixes the toner image subjected to the secondary image transfer onto the sheet.

In the printer 1, the image formation processing unit 10 performs an image forming operation based on various control signals supplied from the control unit 30. Image data is input to the control unit 30 from an external device such as a personal computer or an image reading apparatus, and the image data is subjected to image processing by the control unit 30 and is supplied to each image forming unit 11 through an interface (not shown). In the image forming unit 11K having the black (K) color, for example, the photoreceptor drum 12 is charged to have a predetermined potential by the charger 13 while rotating in the direction of an arrow A, and is exposed to light by the LPH 14 which emits light based on data indicating an image having a black color component from image data items transmitted from the control unit 30. Accordingly, an electrostatic latent image relating to the black (K) color image is formed on the photoreceptor drum 12. The electrostatic latent image formed on the photoreceptor drum 12 is developed by the developing unit 15, and a black (K) toner image is formed on the photoreceptor drum 12. In the image forming units 11Y, 11M, and 11C having other colors, color toner images of yellow (Y), magenta (M), and cyan (C) are formed, respectively, in the same manner as described above.

Each color toner image formed by each image forming unit 11 is subsequently transferred onto the intermediate image transfer belt 20 which circularly moves in the direction of an arrow B by the primary image transfer roll 21, and a toner image in which all color toners are superposed on each other is formed. The toner image on the intermediate image transfer belt 20 is carried to a region (secondary image transfer portion T) on which the secondary image transfer roll 22 is disposed, according to the movement of the intermediate image transfer belt 20 while being held on the intermediate image transfer belt 20. In addition, the sheet is supplied to the secondary image transfer portion T from a sheet holding unit 40 according to a timing of carrying of the toner image by the intermediate image transfer belt 20. The toner image on the intermediate image transfer belt 20 is transferred onto the transported sheet by a transfer voltage generated in the secondary image transfer portion T by the secondary image transfer roll 22.

After that, the sheet to which the toner image is transferred, is separated from the intermediate image transfer belt 20 and is transported to the fuser 45. The toner image on the sheet transported to the fuser 45 is subjected to fixing processing with heat and pressure by the fuser 45 to be fixed onto the sheet. The sheet on which an image formed of the fixed toner image is formed, is discharged to a discharged paper stacking unit 41 provided on a discharge unit of the printer 1.

Meanwhile, the toner (non-transferred toner) attached to the intermediate image transfer belt 20 after the secondary image transfer is removed from the surface of the intermediate image transfer belt 20 by a belt cleaner 25 after completing the secondary image transfer to prepare next image forming cycle. By doing so, the cycle of the image formation in the printer 1 is repeatedly performed by the number of sheets to be printed.

Next, control relating to voltage generation in the secondary image transfer portion T which is a feature of the exemplary embodiment will be described.

The secondary image transfer roll 22 has a function of interposing the sheet transported to the secondary image transfer portion T between the secondary image transfer roll and the intermediate image transfer belt 20 and transferring the toner image carried to the secondary image transfer portion T by the intermediate image transfer belt 20 to the sheet.

Herein, in the exemplary embodiment, the secondary image transfer roll 22, the secondary image transfer portion T and the intermediate image transfer belt 20 correspond to each example of a transfer roll, a transfer unit, and an image holding member of the exemplary embodiment of the invention.

The main power supply 35 includes a secondary image transfer power supply 351. The secondary image transfer power supply 351 is a power supply having a function of generating a voltage between the secondary image transfer roll 22 and the intermediate image transfer belt 20 by applying a voltage to a shaft 231 of the backup roll 23.

The secondary image transfer roll 22 is an ion conductive roll, and a rotation shaft 221 thereof is grounded to a frame (not shown) of the housing 42. The secondary image transfer power supply 351 may perform switching of a positive voltage and a negative voltage applied to the backup roll 23 and adjustment of the voltage. The secondary image transfer power supply 351 corresponds to one example of a power supply of the exemplary embodiment of the invention.

The control unit 30 includes a secondary image transfer control unit 301. This secondary image transfer control unit 301 controls the secondary image transfer power supply 351 by synchronizing with the formation of the toner image or the transportation of the sheet, to control direction and intensity of the voltage generated between the secondary image transfer roll 22 and the intermediate image transfer belt 20.

Specifically, the secondary image transfer control unit 301 allows the secondary image transfer power supply 351 to generate a transfer voltage, a resistance detection voltage having the same polarity as that of the transfer voltage, and a cleaning voltage having a polarity reverse to that of the transfer voltage.

The transfer voltage is a voltage for transferring the toner image on the intermediate image transfer belt 20 to the sheet.

The resistance detection voltage is a voltage generated when detecting electrical resistance of the secondary image transfer portion T. As this resistance detection voltage, a voltage which has the same polarity as that of the transfer voltage and is normally weaker than the transfer voltage. However, the transfer voltage may be set to be low depending on the types of a sheet or an environment, and the resistance detection voltage may be set higher than the transfer voltage.

Herein, the secondary image transfer power supply 351 includes a function of measuring current which flows to the secondary image transfer portion T, and the current is measured when the resistance detection voltage is generated, and the measured result thereof is transmitted to the secondary image transfer control unit 301. In the secondary image transfer control unit 301, a resistance value of the secondary image transfer portion T is calculated based on the voltage applied by the secondary image transfer power supply 351 and the measured current. The secondary image transfer control unit 301 controls the voltage applied to the backup roll 23 by the secondary image transfer power supply 357 based on the calculated resistance value, in order to control the intensity of the transfer voltage. A constant current power supply may be employed as the secondary image transfer power supply 351 to apply a constant current and a resistance detection operation by voltage measurement when applying the constant current may be employed.

The cleaning voltage has a polarity reverse to that of the transfer voltage, and one of operations thereof is to return the toner attached to the secondary image transfer roll 22 to the intermediate image transfer belt 20. The toner returned onto the intermediate image transfer belt 20 is removed from the upper portion of the intermediate image transfer belt 20 by the belt cleaner 25. The operations other than this cleaning operation will be described later. The secondary image transfer control unit 301 corresponds to one example of a control unit of the exemplary embodiment of the invention.

The control unit 30 further includes a counter 302. This counter 302 is a counter which counts the number of accumulated sheets to be printed. Herein, as will be described later, the function of the counter is for preventing generation of image quality defects relating to the voltage between the secondary image transfer roll 22 and the intermediate image transfer belt 20, and a counted value of the counter 302 is reset when the secondary image transfer roll 22 is replaced with a new product by maintenance.

The printer 1 further includes an environment sensor 31. The environment sensor 31 is a sensor for detecting a temperature or humidity in the housing 42 of the printer. The detected result is transmitted to the control unit 30.

As the secondary image transfer roll 22, the ion conductive roll is employed as described above. Herein, properties of this ion conductive roll and image quality defects which may occur due to the same will be described.

The ion conductive roll has a property in which ions are eccentrically distributed due to electrification and therefore the electrical resistance increases. Herein, since a peripheral surface of the secondary image transfer roll 22 comes into contact with the intermediate image transfer belt 20 and the rotation shaft 221 at the center thereof is grounded, the current mainly flows in a radial direction and the ions are mainly distributed eccentrically in the radial direction of the roll. However, not only are the ions distributed eccentrically in the radial direction, but the unevenness is also generated in a rotation direction. The detection of the resistance by generating the resistance detection voltage as described above is performed mainly for detecting a change in resistance of the secondary image transfer roll 22 originated by the eccentric distribution of the ions. Not only are the ions distributed eccentrically in the radial direction, but the unevenness is also generated in a rotation direction, and thus in order to accurately detect the resistance, it is necessary to detect the resistance over one circuit of the secondary image transfer roll 22 which rotates in the direction of the arrow C, and in order to more accurately detect the resistance, it is necessary to average the detected results over plural circuits.

If the resistance of the secondary image transfer roll 22 increases due to the eccentric distribution of the ions, it is necessary to generate a stronger transfer voltage, and the secondary image transfer control unit 301 controls the secondary image transfer power supply 351 to output a strong voltage. By doing so, particularly in an environment with a low temperature and low humidity, discharge easily occurs between the secondary image transfer roll 22 and the intermediate image transfer belt 20, and image quality defects due to the discharge (white spots due to the discharge) easily occur. In contrast, in an environment with a high temperature and high humidity, since the resistance decreases although the eccentric ion distribution level is substantially the same as described above, the amount of the current which is caused to flow becomes great and the eccentric ion distribution easily proceeds.

Since the cleaning voltage described above has a polarity reverse to that of the transfer voltage, the cleaning voltage has a function of causing the current to flow in reverse and alleviating the eccentric ion distribution. However, the eccentric ion distribution does not disappear and the resistance also increases with time.

Accordingly, in order to suitably control the intensity of the transfer voltage, first, it is necessary to accurately detect the resistance to set the transfer voltage having the intensity according to the resistance. If resistance detection error is great and a resistance value lower than the actual value is detected, an excessively weak transfer voltage may be obtained and the image quality defects due to transfer failure may occur, or if a resistance value higher than the actual value is detected, an excessively strong transfer voltage may be obtained and the image quality defects due to the discharge may occur.

Although the resistance is accurately detected, if the resistance value is excessively large as it is, a strong transfer voltage may be obtained and the image quality defects due to the discharge may occur as well. Accordingly, it is necessary to apply a sufficient cleaning voltage and sufficiently alleviate the eccentric ion distribution to decrease the resistance value.

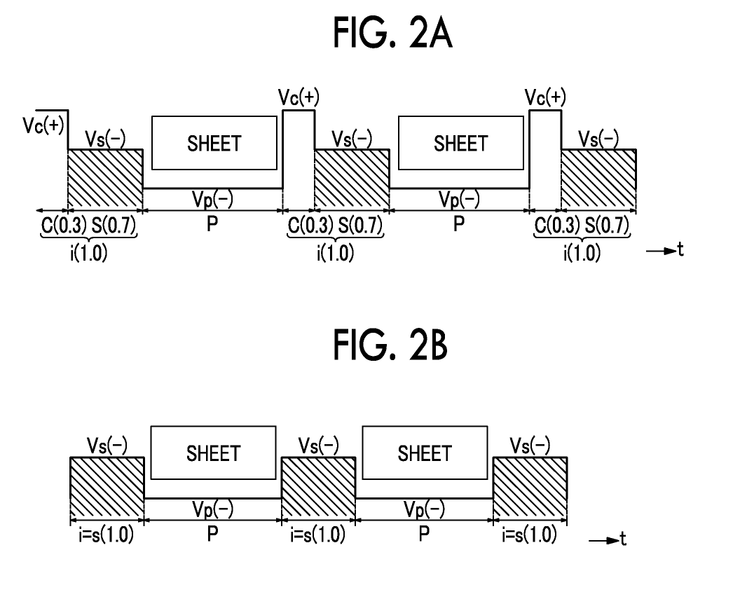

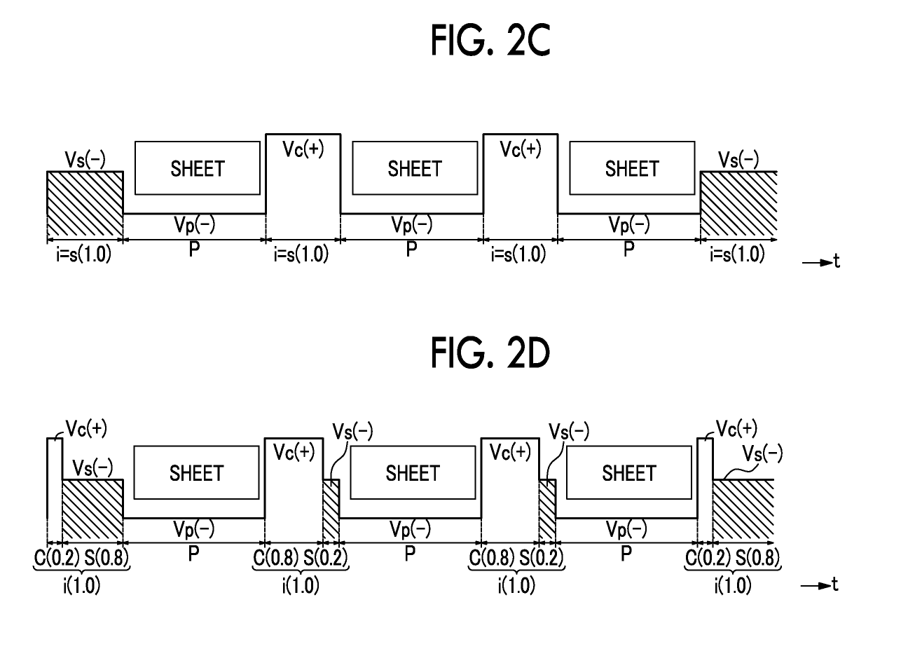

FIGS. 2A to 2D are diagrams transversely showing switching sequences of various voltages in a continuous traveling mode. A horizontal axis indicates time. The continuous traveling mode is a mode for transferring and fixing a toner image to each continuously transported sheet, to form images on the continuously transported sheets.

In FIGS. 2A to 2D, a period of time labeled as “sheet” is a period of time in which the sheet passes through the secondary image transfer portion T. This period of time is referred to as a “transfer interval p” herein. The transfer voltage Vp (−) for secondarily transferring the toner image on the intermediate image transfer belt 20 to the sheet is applied in this transfer interval p.

A period of time interposed between “sheet” and “sheet” adjacent to each other is a period of time in which one sheet has already passed through the secondary image transfer portion T and the next sheet has not yet arrived at the secondary image transfer portion T. Herein, this period of time is referred to as a “non-arriving interval i”.

A cleaning interval c and a resistance detection interval s are included in this non-arriving interval i. A cleaning voltage Vc (+) is applied in the cleaning interval c, and a resistance detection voltage Vs (−) is applied in the resistance detection interval s.

Herein, a polarity of the transfer voltage Vp is represented by (−). In this case, since the cleaning voltage Vc has a polarity reverse to that of the transfer voltage Vp, the polarity thereof is (+). The resistance detection voltage Vs has the same polarity (−) as that of the transfer voltage Vp.

### Comparative Examples

FIG. 2A is a diagram showing a sequence of the first comparative example.

Herein, when a length of each non-arriving interval i is set to 1.0, each non-arriving interval i is divided into the cleaning interval c (0.3) having a length of 0.3 and the resistance detection interval s (0.7) having a length of 0.7. Herein, a long period of time is secured as the non-arriving interval i, and both the cleaning interval c (0.3) and the resistance detection interval s (0.7) having sufficient lengths are secured. In this case, since the cleaning interval c (0.3) having a sufficient length is secured, the eccentric ion distribution of the secondary image transfer roll 22 is sufficiently alleviated and an increase in resistance due to eccentric ion distribution is sufficiently suppressed. In addition, since the resistance detection interval s (0.7) having a sufficient length is secured, it is possible to detect the resistance value of the secondary image transfer portion T with sufficient accuracy.

However, in a case of the first comparative example of FIG. 2A, since it is necessary to secure a long period of time as the non-arriving interval i, it is difficult to perform high-speed traveling of the sheet or to shorten the gap between the sheet and the sheet, and it is difficult to increase productivity of image formation. If shortening the gap between the sheet and the sheet or performing high-speed traveling is attempted, it is necessary to set one of or both the cleaning interval c and the resistance detection interval s to be short periods of time, or it is necessary to exclude one of them.

### Second Comparative Example

FIG. 2B is a diagram showing a sequence of the second comparative example.

Herein, the gap between the sheet and the sheet at the time of continuous traveling is shortened, and as a result, a short non-arriving interval i is obtained and the entire interval of the non-arriving interval i is the resistance detection interval s (1.0). In this case, the resistance is accurately detected, but the eccentric ion distribution due to the cleaning voltage Vc (+) is not alleviated in the continuous traveling, high resistance tends to be obtained, the image quality defects due to the discharge may occur with high possibility.

Hereinafter, various examples according to the exemplary embodiment described above will be described, based on the first and second comparative examples.

In the printer 1 of the exemplary embodiment, the resistance detection voltage Vp (−) and the cleaning voltage Vc (+) are generated in the non-arriving interval i in the continuous traveling mode, while switching a generation time ratio of the resistance detection interval s and the cleaning interval c in one non-arriving interval i, during the continuous traveling mode. Herein, the generation time ratio in one non-arriving interval i is referred to as a “single interval ratio” to differentiate it from a ratio of another generation time which will be described later.

### First Example

Herein, the resistance detection voltage Vs (−) and the cleaning voltage Vc (+) are applied while turning on and off the resistance detection interval s, for each non-arriving interval i.

Herein, when the ratio is represented by the ratio of the cleaning interval c and the ratio of the cleaning interval c is 0.0 and 1.0, each single interval ratio is set as 0.0 and 1.0. The same applies hereinafter. The “single interval ratio” is a value defined as the ratio (c/(c+s)) between the cleaning interval c and the resistance detection interval s, and intervals other than the cleaning interval c and the resistance detection interval s may be included in one non-arriving interval i.

In FIG. 2C, the ratio of the cleaning interval c in one non-arriving interval i, that is, the single interval ratio, is cyclically repeated in a pattern of 0.0→1.0→1.0→0.0→ . . . . Herein, the ratio of the cleaning interval c, that is, the single interval ratio which is 0.0, means that the entire area of the non-arriving interval i is the resistance detection interval s and the resistance detection voltage Vs (−) is generated over the entire area of the non-arriving interval i. In the same manner as described above, the ratio of the cleaning interval c, that is, the single interval ratio which is 1.0, means that the entire area of the non-arriving interval i is the cleaning interval c and the cleaning voltage Vc (+) is generated over the entire area of the non-arriving interval i.

In a case of the first example shown in FIG. 2C, regarding an average generation time ratio over the plural non-arriving interval i (herein, referred to as an “average ratio”), the ratio of the cleaning interval c in which the cleaning voltage Vc (+) is generated is 0.67, and the resistance detection interval s in which the resistance detection voltage Vs (−) is generated is 0.33.

Herein, in the same manner as in the case of the single interval ratio, the ratio is represented by the ratio of the cleaning interval c, and the average ratio is set as 0.67. The same applies hereinafter.

In the first example, a counted value of the counter 302 shown in FIG. 1 or a temperature and humidity measured value by the environment sensor 31 is applied to other control of the printer 1, but is not applied to control of voltage switching in the secondary image transfer portion T.

Herein, the example in which the entire area of one non-arriving interval i is any one of the cleaning interval c and the resistance detection interval s is shown, but an interval in which other voltage is applied may be included in one non-arriving interval i, as described above. As an example of the other voltage, for example, a part of an interval in which the transfer voltage is applied may be included in the non-arriving interval i, an interval of 0 volt may be temporarily generated when switching the voltage from a positive voltage to a negative voltage, or a voltage applying interval in another control operation may be included.

That is, as described above, the “single interval ratio” is a value defined as the ratio (c/(c+s)) between the cleaning interval c and the resistance detection interval s.

### Second Example

FIG. 2D is a diagram showing a sequence of the second example of the printer 1 of the exemplary embodiment.

Herein, both the resistance detection voltage Vs (−) and the cleaning voltage Vc (+) are generated in each of all non-arriving intervals i, and the resistance detection voltage Vs (−) and the cleaning voltage Vc (+) are generated while switching the single interval ratio during the continuous traveling mode.

In detail, in FIG. 2D, the single interval ratio is repeated in a pattern of 0.2→0.8→0.8→0.2→ . . . . The average ratio is 0.6.

Even in a case of switching the single interval ratio to 0.0 and 1.0 for each non-arriving interval i shown in FIG. 2C, or even in a case where 0.0<single interval ratio<1.0 in all non-arriving intervals i, that is, a case where both the resistance detection interval s and the cleaning interval c are included in all non-arriving intervals i shown in FIG. 2D, the average ratio is desirably in a range of 0.2 to 0.8. If the average ratio is lower than 0.2, the alleviation of the eccentric ion distribution is not sufficient, and an excessive increase in resistance may occur with high probability. As described above, if the resistance excessively increases, the discharge may occur particularly in an environment with a low temperature and low humidity, and image quality defects due to the discharge may occur. In contrast, if the average ratio exceeds 0.8, the resistance detection accuracy decreases. If the resistance detection accuracy decreases, an appropriate transfer voltage Vp (−) may not be formed; for example, the transfer voltage Vp (−) may be excessively weak such that transfer failure occurs, and the image quality defects due to the transfer failure may occur. Alternatively, if the transfer voltage Vp (−) is excessively strong, the discharge may occur in the same manner as in the case of the excessive increase in resistance, and the image quality defects due to the discharge may occur.

Although the average ratio is in a range of 0.2 to 0.8, an appropriate average ratio changes depending on a roll diameter, a temperature and humidity of the environment, the number of accumulated sheets to be printed, and the like.

Hereinafter, examples subsequent to the third example will be further described, but the examples are in the same manner as in FIG. 2C or FIG. 2D except for a different change pattern or a different average ratio of the single interval ratios, and therefore drawings for examples subsequent to the third example will be omitted.

### Third Example

Herein, the single interval ratio is repeated in a pattern of 0.4→1.0→1.0→0.4→1.0→1.0→ . . . . In this case, the average ratio is 0.8.

### Fourth Example

In the fourth example, the change pattern or the average ratio of the single interval ratios is switched based on the resistance detection result.

Herein, when the single interval ratio is repeated in a monotonous pattern of 0.2→0.2→0.2→ . . . (average ratio of 0.2) for prioritizing the resistance detection accuracy, an average of five cases of movement in the resistance detection result is increased to exceed a threshold value of the resistance value, and accordingly, the single interval ratio is switched to a pattern of 0.4→1.0→1.0→0.4→1.0→1.0→ . . . (average ratio of 0.8) from the next printing thereof during the continuous traveling mode.

As in the fourth example, in a case where the resistance value is increased to exceed the threshold value by performing the continuous traveling in the conditions for prioritizing the resistance detection accuracy, it is necessary to switch the pattern thereof to a pattern of lengthening the cleaning interval c (average ratio is desirably approximately from 0.5 to 0.8) and to alleviate an increase in resistance (eccentric ion distribution) of the secondary image transfer roll 22.

In a case where it is necessary to switch the pattern such as when the resistance value is increased to exceed the threshold value, as in the fourth example, the pattern may be switched during the continuous traveling mode, or the pattern may be fixed during the continuous traveling mode and may be switched from the next operation.

### Fifth Example

The pattern or the average ratio of the single interval ratios is also switched based on the resistance detection result, in the fifth example.

Herein, since an average of five times of movement of the resistance value is lower than the threshold value during the continuous traveling for prioritizing the cleaning with a pattern of the single interval ratio of 0.5→1.0→1.0→1.0→1.0→0.5→1.0→1.0→1.0→1.0→ . . . (average ratio of 0.9), the single interval ratio is switched to a pattern for prioritizing the resistance detection accuracy, as 0.1→0.4→0.4→0.1→0.4→0.4→ . . . (average ratio of 0.3) from the next printing.

As in the fifth example, in a case where the resistance value is lower than the threshold value by performing the continuous traveling in the conditions for prioritizing the generation of the cleaning voltage (suppression of resistance by alleviation of the eccentric ion distribution), it is desirable that the resistance detection interval s be lengthened (average ratio is desirably approximately from 0.2 to 0.4) to increase the resistance detection accuracy, and occurrence of image defects accompanied with the resistance value detection error be suppressed.

### Sixth Example

In the sixth example, the pattern or the average ratio of the single interval ratios is switched based on the measurement result (temperature and humidity detection result) of environment information obtained by the environment sensor 31.

Herein, since a measured value of the environment information obtained by the environment sensor 31 exceeds a threshold value (for example, “7”) during the continuous traveling in a pattern of the single interval ratio of 0.2→0.2→0.2→0.2→ . . . (average ratio of 0.2), the average ratio is switched to a pattern of 0.2→1.0→1.0→0.2→1.0→1.0→ . . . (average ratio of 0.7) from the next printing.

Herein, the environment information is a function of an absolute humidity calculated from a temperature and relative humidity, and is assigned numerical values of “1” to “9” so that as the numerical value is large, the environment is the environment with a low temperature and low humidity. For example, an environment 1 indicates a temperature of 28 degrees and relative humidity of 85% and an environment 9 indicates a temperature of 10 degrees and relative humidity of 15%.

When the continuous traveling is performed in the environment with a high temperature and high humidity (small value of environment information), the current which flows to the secondary image transfer roll 22 is large in amount and the eccentric ion distribution is easily accelerated. Herein, in the sixth example, when the value of the environment information exceeds the threshold value (for example, 7) to indicate the environment with a low temperature and low humidity in which the discharge due to the increase in resistance easily occurs, the pattern is switched to a pattern with a high average ratio (average ratio is desirably approximately from 0.5 to 0.8) to alleviate the increase in resistance (eccentric ion distribution) of the secondary image transfer roll 22.

### Seventh Example

In the seventh example, the change pattern or the average ratio of the single interval ratios is switched based on the number of accumulated sheets to be printed.

Herein, since the counted value (accumulation value of the sheets to be printed) of the counter 302 exceeds the threshold value (for example, 1000 sheets) during the continuous traveling with a pattern of the single interval ratio of 0.2→0.2→0.2→0.2→ . . . (average ratio of 0.2), the single interval ratio is switched to 0.2→1.0→1.0→0.2→1.0→1.0→ . . . (average ratio of 0.7) from the next printing during the continuous traveling.

Since the increase in resistance (eccentric ion distribution) of the secondary image transfer roll 22 proceeds over time if the number of sheets to be printed is increased, herein, in a case where the number of sheets to be printed exceeds the threshold value, the pattern is switched to a pattern of lengthening the cleaning interval c (average ratio is desirably approximately from 0.5 to 0.8) and the increase in resistance (eccentric ion distribution) of the secondary image transfer roll 22 is alleviated.

### Test Result

Herein, for first and second comparative examples and first to seventh examples, generation of image quality defects due to the increase in resistance of the secondary image transfer roll 22 and the generation of the image quality defects due to the decrease in the resistance detection accuracy, when continuous traveling is performed for 20000 A4-sized sheets, are investigated. It may be difficult to differentiate the image quality defects due to the increase in resistance, and the image quality defects due to the generation of the excessively strong transfer voltage Vp (−) due to the decrease in the resistance detection accuracy from each other only by observing the images, and herein, when a given type of image quality defects occurs, the resistance detection is continuously performed with high accuracy, to investigate whether the image quality defects are the image quality defects due to the increase in resistance or the image quality defects due to the decrease in resistance detection accuracy.

In the first and second comparative examples and the first to seventh examples, the example with no particular description of the environment information has the level of the environment 5 (temperature of 22 degrees and relative humidity of 55%).

Hereinafter, test results of the first and second comparative examples and the first to seventh examples will be described.
In a case of the first comparative example, no image quality defects occur. In the case of the first comparative example, by lengthening the gap between the sheet and the sheet, the long non-arriving interval i is secured, and sufficient lengths of time of both the cleaning interval c and the resistance detection interval s are secured in each non-arriving interval i. As described above, the image quality defects do not occur in the first comparative example due to loss of productivity of the image formation, and the loss of the productivity is not acceptable.
In a case of the second comparative example, the image quality defects due to the increase in resistance occur. In the case of the second comparative example, the non-arriving interval i is short compared to that in the first comparative example. Accordingly, there is no problem in the productivity of the image formation. However, the entire interval of time of the non-arriving interval i is used as the resistance detection interval s and the cleaning interval c is not obtained. Therefore, the increase in resistance proceeds and the image quality defects at an unacceptable level occur.
In cases of the first and second examples, the generation of the image quality defects is not observed. However, in the first and second examples, since the pattern and the average ratio of the single interval ratios are fixed, the average ratio may not correspondingly change until a great change in resistance occurs due to the environmental change or with time.
In a case of the third example, although it is at an acceptable level, slight degradation of image quality is observed with the resistance detection error. The average ratio of the third example is 0.8 and this is in a desirable range, but it is substantially the upper limit, and accordingly, the slightly unstable image quality is considered. Also in the third example in the same manner as in the first and second examples, since the pattern and the average ratio of the single interval ratios are fixed, the average ratio may not correspondingly change until a great change in resistance occurs due to the environmental change or with time.
In a case of the fourth example, before switching the pattern and the average ratio of the single interval ratios, the image quality defects which are considered to be caused by the increase in resistance occur while they are at an acceptable level. After the switching, the occurrence of the image quality defects is not observed. However, since the average ratio is switched so as to be the upper limit in a desirable range, the image quality defects at the acceptable level due to the decrease in resistance detection accuracy may occur depending on the environment conditions.
In a case of the fifth example, since the average ratio is set as 0.9 before the switching, the image quality defects due to the resistance detection failure occur, but the image quality defects disappear by performing switching.
In a case of the sixth example, slight image quality defects at the acceptable level due to the increase in resistance are observed before the switching, but the occurrence of image quality defects is not observed after the switching.
Also in a case of the seventh example, in the same manner as in the sixth example, slight image quality defects at the acceptable level due to the increase in resistance are observed before the switching, but the slight image quality defects also disappear after the switching.

As described above, according to the exemplary embodiment, since the resistance detection voltage Vs (−) and the cleaning voltage Vc (+) are generated while switching the single interval ratios during the continuous traveling, high productivity of the image formation is secured and stable secondary image transfer is performed. In addition, when the pattern of the single interval ratios is switched depending on the detected resistance value and environment value, or with time, stable secondary image transfer may be performed although various changes are performed in the conditions.

Herein, the description has been performed considering the case of the constant voltage applying, but the exemplary embodiment of the invention may also be applied as it is to a system of generating the voltage by the constant current applying.

Herein, the example in which the exemplary embodiment of the invention is applied to the printer 1 shown in FIG. 1 has been described, but the exemplary embodiment of the invention is not applied only to the type of printer shown in FIG. 1. The exemplary embodiment of the invention may be widely applied to a type of image forming apparatus which forms a toner image to be transferred to a sheet, that is, a so-called electrophotographic image forming apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transfer device comprising:
a transfer roll that interposes a sheet transported to a transfer unit between the transfer roll and an image holding member which holds a toner image and carries the toner image to the transfer unit, to transfer the toner image to the sheet;
a power supply that generates a voltage between the transfer roll and the image holding member; and
a control unit that causes the power supply to generate a transfer voltage for transferring the toner image onto the sheet, a resistance detection voltage having a same polarity as a polarity of the transfer voltage, and a cleaning voltage having a polarity reverse to the polarity of the transfer voltage,
wherein the control unit causes the power supply to generate the transfer voltage in a transfer interval in which each sheet passes through the transfer unit, in a continuous traveling mode in which toner images are transferred to the plurality of continuously transported sheets, and generates the resistance detection voltage and the cleaning voltage in a non-arriving interval in which a sheet has already passed through the transfer unit and a next sheet has not arrived at the transfer unit while switching a single interval ratio which is a generation time ratio in the non-arriving interval between the resistance detection voltage and the cleaning voltage, during the continuous traveling mode.

2. The transfer device according to claim 1,
wherein the control unit causes the power supply to turn at least the resistance detection voltage on and off for each non-arriving interval in the continuous traveling mode.

3. The transfer device according to claim 1,
wherein the control unit causes the power supply, in the continuous traveling mode, to generate both the resistance detection voltage and the cleaning voltage in each non-arriving interval, and to generate the resistance detection voltage and the cleaning voltage while switching the single interval ratio during the continuous traveling mode.

4. The transfer device according to claim 1,
wherein the control unit causes the power supply to generate the resistance detection voltage and the cleaning voltage, while adjusting an average ratio which is an average generation time ratio over the plurality of non-arriving intervals between the resistance detection voltage and the cleaning voltage, based on one or more of a resistance detection result, temperature and humidity information, and a number of accumulated sheets to be traveled.

5. The transfer device according to claim 2,
wherein the control unit causes the power supply to generate the resistance detection voltage and the cleaning voltage, while adjusting an average ratio which is an average generation time ratio over the plurality of non-arriving intervals between the resistance detection voltage and the cleaning voltage, based on one or more of a resistance detection result, temperature and humidity information, and a number of accumulated sheets to be traveled.

6. The transfer device according to claim 3,
wherein the control unit causes the power supply to generate the resistance detection voltage and the cleaning voltage, while adjusting an average ratio which is an average generation time ratio over the plurality of non-arriving intervals between the resistance detection voltage and the cleaning voltage, based on one or more of a resistance detection result, temperature and humidity information, and a number of accumulated sheets to be traveled.

7. An image forming apparatus comprising:
the transfer device according to claim 1;
a toner image forming device that forms a toner image on the image holding member; and
a fixing device that fixes a toner image on a sheet to which the toner image is transferred, onto the sheet.

8. An image forming apparatus comprising:
the transfer device according to claim 2;
a toner image forming device that forms a toner image on the image holding member; and
a fixing device that fixes a toner image on a sheet to which the toner image is transferred, onto the sheet.

9. An image forming apparatus comprising:
the transfer device according to claim 3;
a toner image forming device that forms a toner image on the image holding member; and
a fixing device that fixes a toner image on a sheet to which the toner image is transferred, onto the sheet.

10. An image forming apparatus comprising:
the transfer device according to claim 4;
a toner image forming device that forms a toner image on the image holding member; and
a fixing device that fixes a toner image on a sheet to which the toner image is transferred, onto the sheet.

11. An image forming apparatus comprising:
the transfer device according to claim 5;
a toner image forming device that forms a toner image on the image holding member; and
a fixing device that fixes a toner image on a sheet to which the toner image is transferred, onto the sheet.

12. An image forming apparatus comprising:
the transfer device according to claim 6;
a toner image forming device that forms a toner image on the image holding member; and
a fixing device that fixes a toner image on a sheet to which the toner image is transferred, onto the sheet.

13. The image forming apparatus according to claim 7,
wherein the toner image forming device forms a toner image on the image holding member by performing primary image transfer of the toner image onto the image holding member, and
the transfer device performs secondary image transfer of the toner image transferred onto the image holding member, onto the sheet.

14. The image forming apparatus according to claim 8,
wherein the toner image forming device forms a toner image on the image holding member by performing primary image transfer of the toner image onto the image holding member, and
the transfer device performs secondary image transfer of the toner image transferred onto the image holding member, onto the sheet.

15. The image forming apparatus according to claim 9,
wherein the toner image forming device forms a toner image on the image holding member by performing primary image transfer of the toner image onto the image holding member, and
the transfer device performs secondary image transfer of the toner image transferred onto the image holding member, onto the sheet.

16. The image forming apparatus according to claim 10,
wherein the toner image forming device forms a toner image on the image holding member by performing primary image transfer of the toner image onto the image holding member, and
the transfer device performs secondary image transfer of the toner image transferred onto the image holding member, onto the sheet.

17. The image forming apparatus according to claim 11,
wherein the toner image forming device forms a toner image on the image holding member by performing primary image transfer of the toner image onto the image holding member, and
the transfer device performs secondary image transfer of the toner image transferred onto the image holding member, onto the sheet.

18. The image forming apparatus according to claim 12,
wherein the toner image forming device forms a toner image on the image holding member by performing primary image transfer of the toner image onto the image holding member, and
the transfer device performs secondary image transfer of the toner image transferred onto the image holding member, onto the sheet.
